(19) United States
(12) Patent Application Publication
(10) Pub. No.: US 2017/0048574 A1
(43) Pub. Date: Feb. 16, 2017

(54) SIMULTANEOUS PRESENTATION OF CONTENT ON A SECOND DEVICE

(71) Applicant: Google Inc., Mountain View, CA (US)

(72) Inventors: David Young Chung, Palo Alto, CA (US); Laura Paragano, San Francisco, CA (US)

(73) Assignee: Google Inc., Mountain View, CA (US)

(21) Appl. No.: 14/168,691

(22) Filed: Jan. 30, 2014

(51) Int. Cl. H04N 21/41; H04N 21/81; H04N 21/234

(52) U.S. Cl. CPC H04N 21/4126; H04N 21/23424; H04N 21/812

(57) ABSTRACT

Methods, systems, and apparatus include computer programs encoded on a computer-readable storage medium, including a method for providing content. A controlling device is identified that includes a display for presenting content to a user. An indication is received from an application running on the controlling device of an intent by the user to receive a first content item on a separate but co-located presentation device. Based on the first content item, additional content items are selected for simultaneous delivery on the controlling device while presenting the first content item on the co-located presentation device. The additional content items include interaction points that are configured to enable the user to interact with the additional content items, which are delivered to the controlling device. User input is received that is in the form of an interaction with an interaction point. The interaction is attributed to the presenting of the first content item.

### BACKGROUND

This specification relates to information presentation.

The Internet provides access to a wide variety of resources. For example, video and/or audio files, as well as webpages for particular subjects or particular news articles, are accessible over the Internet. Access to these resources presents opportunities for other content (e.g., advertisements) to be provided with the resources. For example, a webpage can include slots in which content can be presented. These slots can be defined in the webpage or defined for presentation with a webpage, for example, along with search results. Content in these examples can be of various formats, while the devices that consume (e.g., present) the content can be equally varied in terms of their type and capabilities.

Content slots can be allocated to content sponsors as part of a reservation system, or in an auction. For example, content sponsors can provide bids specifying amounts that the sponsors are respectively willing to pay for presentation of their content. In turn, an auction can be run, and the slots can be allocated to sponsors according, among other things, to their bids and/or a likelihood that the user will interact with the content presented. Some users may have multiple user devices capable of receiving content, and each of the user devices may have different display capabilities.

### SUMMARY

In general, one innovative aspect of the subject matter described in this specification can be implemented in methods that include a computer-implemented method for providing content. The method includes identifying a controlling device that includes a display for presenting content to a user. The method further includes receiving an indication from an application running on the controlling device of an intent by the user to receive a first content item on a separate but co-located presentation device. The method further includes selecting, by one or more processors, one or more additional content items for simultaneous delivery on the controlling device while presenting the first content item on the co-located presentation device, wherein the selecting is based at least in part on the first content item, and wherein the one or more additional content items include one or more interaction points that are configured to enable the user to interact with the one or more additional content items. The method further includes delivering, by one or more processors, the one or more additional content items to the controlling device for presentation coincident with the presentation of the first content item on the co-located presentation device including delivering a second different content item including a first interaction point. The method further includes receiving user input in the form of an interaction with the first interaction point. The method further includes attributing the interaction to the presenting of the first content item.

These and other implementations can each optionally include one or more of the following features. The controlling device can be a mobile communication device or a tablet computer, and the presentation device can be a television. The first content item can be an Internet content item and the second different content item can be selected based at least in part on content or metadata of the Internet content item, wherein the Internet content item is selected from the group comprising a multi-media content item, a graphical display item, an audio content item, an executable software application, or an Internet resource. The first content item can be a video content item, wherein the video content item includes or is associated with a first advertisement that is presented before, during or after the presentation of the video content item, and wherein the second different content item is a second advertisement that is related to the first advertisement. The second advertisement can be a mirror of the first advertisement. The second advertisement can include an interaction point that corresponds to an interaction point that is presented but disabled on the first advertisement. Receiving an indication can include receiving a request to initiate a session for presenting content on the co-located presentation device, wherein the request includes an identifier for the first content item. Selecting one or more additional content items can include identifying eligible content items from an inventory of content items, and eligible content items can include content items that are adapted for coordinated presentation on the controlling device in view of simultaneously displayed content on the co-located presentation device. The method can further include providing additional content to the co-located presentation device based on the interaction. The method can further include providing an advertiser interface for configuring a campaign, the campaign including both a first advertisement to be shown in conjunction with the first content item when it is presented on the co-located presentation device and a second advertisement to be presented on the controlling device coincident with the presentation of the first advertisement on the co-located presentation device. Selecting one or more additional content items can include selecting a campaign associated with a content sponsor for providing the second different content item, the campaign having two or more associated content items, one for presentation on the co-located presentation device and one for presentation on the controlling device. Attributing includes crediting a conversion that is related to the interaction to the presentation of the first content item.

In general, another innovative aspect of the subject matter described in this specification can be implemented in computer program products that include a computer program product tangibly embodied in a computer-readable storage device and comprising instructions. The instructions, when executed by one or more processors, cause the processor to: identify a controlling device that includes a display for presenting content to a user; receive an indication from an application running on the controlling device of an intent by the user to receive a first content item on a separate but co-located presentation device; select one or more additional content items for simultaneous delivery on the controlling device while presenting the first content item on the co-located presentation device, wherein the selecting is based at least in part on the first content item, and wherein the one or more additional content items include one or more interaction points that are configured to enable the user to interact with the one or more additional content items; deliver the one or more additional content items to the controlling device for presentation coincident with the presentation of the first content item on the co-located presentation device including delivering a second different content item including a first interaction point; receive user input in the form of an interaction with the first interaction point; and attribute the interaction to the presenting of the first content item.

These and other implementations can each optionally include one or more of the following features. The controlling device can be a mobile communication device or a tablet computer, and the presentation device can be a television. The first content item can be an Internet content item and the second different content item can be selected based at least in part on content or metadata of the Internet content item, wherein the Internet content item is selected from the group comprising a multi-media content item, a graphical display item, an audio content item, an executable software application, or an Internet resource. The first content item can be a video content item, wherein the video content item includes or is associated with a first advertisement that is presented before, during or after the presentation of the video content item, and wherein the second different content item is a second advertisement that is related to the first advertisement.

In general, another innovative aspect of the subject matter described in this specification can be implemented in systems, including a system comprising one or more processors and one or more memory elements including instructions. The instructions, when executed, cause the one or more processors to: identify a controlling device that includes a display for presenting content to a user; receive an indication from an application running on the controlling device of an intent by the user to receive a first content item on a separate but co-located presentation device; select one or more additional content items for simultaneous delivery on the controlling device while presenting the first content item on the co-located presentation device, wherein the selecting is based at least in part on the first content item, and wherein the one or more additional content items include one or more interaction points that are configured to enable the user to interact with the one or more additional content items; deliver the one or more additional content items to the controlling device for presentation coincident with the presentation of the first content item on the co-located presentation device including delivering a second different content item including a first interaction point; receive user input in the form of an interaction with the first interaction point; and attribute the interaction to the presenting of the first content item.

These and other implementations can each optionally include one or more of the following features. The controlling device can be a mobile communication device or a tablet computer, and the presentation device can be a television. The first content item can be an Internet content item and the second different content item can be selected based at least in part on content or metadata of the Internet content item, wherein the Internet content item is selected from the group comprising a multi-media content item, a graphical display item, an audio content item, an executable software application, or an Internet resource. The first content item can be a video content item, wherein the video content item includes or is associated with a first advertisement that is presented before, during or after the presentation of the video content item, and wherein the second different content item is a second advertisement that is related to the first advertisement.

Particular implementations may realize none, one or more of the following advantages. Users can receive and interact with content items on mobile devices that are used for controlling presentation devices, e.g., receiving, on the mobile devices, pre-roll advertisements, product placement advertisements, and/or advertisements relevant to what they're watching on a second device, e.g., a video on a second device (a presentation device). Content sponsors can create campaigns that include content items (e.g., advertisements) that are tailored to a user's environment, e.g., for presentation when a mobile device is being used to control content presented on a presentation device. Content sponsors can create content items that are synchronized with content being experienced on a nearby presentation device, e.g., so that an advertisement is provided on a first device (e.g., a controlling device) coincident with related content that is shown on a second different but co-located device (e.g., a presentation). Devices that are being used simply to control presentations on other devices can be served content items which can improve the user experience and relevancy of content being presented on the other devices. Content sponsors can adjust their bids for the presentation of their content for situations in which content items are presented to controlling devices.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for delivering content.

FIG. 2 shows an example system for providing content.

FIG. 3 is a flowchart of an example process for providing additional content on a device controlling a presentation device.

FIG. 4 is a block diagram of an example computer system that can be used to implement the methods, systems and processes described in this disclosure.

Like reference numbers and designations in the various drawings indicate like elements.

### DETAILED DESCRIPTION

Systems, methods, and computer program products are described for delivering content to a presentation device that is separate from, but co-located with, a controlling device. For example, a controlling device, such as a mobile communication device or a tablet computer, can be identified that includes a display for presenting content to a user. The user can use the controlling device, for example, to initiate and control content that is presented on the presentation device (e.g., a television (TV)). User input can include, for example, using an application running on the controlling device to select a first content item (e.g., a specific video) that is to be shown on the presentation device (e.g., the TV). At a content server system, for example, an indication can be received from the application of an intent by the user to present (either directly or indirectly as will be discussed below) a first content item on a separate but co-located presentation device. The content server system, for example, can select one or more additional content items (e.g., advertisements) for simultaneous delivery on the controlling device while the first content item (e.g., the video) is presented on the co-located presentation device. The selecting can be based, at least in part, on the first content item. The one or more additional content items can include one or more interaction points that are configured to enable the user to interact with the one or more additional content items. Interaction points can include, for example, clickable links or other controls that the user can use to respond to the content provided in the content item, such as to make a purchase. The one or more additional content items can be delivered to the controlling device for presentation coincident with the presentation of the first content item on the co-located presentation device. This can include delivering a second different content item that includes a first interaction point. User input (e.g., user actions constituting a conversion) can be received by the content server system that is in the form of an interaction with the first interaction point. The interaction can be attributed to the presentation of the first content item.

Although examples provided herein include the use of two devices that are co-located, other configurations are possible. In some implementations, configurations can exist in which more than two devices are used, e.g., including plural of either or both of controlling devices and presentation devices. In some implementations, the controlling device and the presentation device need not be co-located, e.g., if the controlling device controls content provided to one or more remote presentation devices. Other configurations are possible.

Presentation devices can typically have enhanced presentation characteristics, relative to the display of a controlling device. In some implementations, the enhanced presentation characteristics can include, for example, display characteristics (e.g., higher resolution and/or a larger screen area) or audio characteristics (e.g., higher-quality speakers and/or other sound components). Other enhanced presentation characteristics are possible. The characteristics of presentation devices (e.g., televisions) can make them suitable for presenting rich content (e.g., videos), and the presentation devices can be initiated and controlled by controlling devices (e.g., mobile devices or laptop computers).

While examples are provided for simultaneous presentation of content items on the controlling (e.g., initiating) and presentation devices, simultaneous presentation can also include and/or refer to presentations that are relatively simultaneous or within a similar timeframe. For example, the content items can be presented at exactly the same time (e.g. mirrored), within a few seconds of each other, or using a larger delay (e.g., minutes or hours). Also, the content items can be presented in a way so that the user experiences a coordinated presentation, e.g., that appears to have the content items communicating with each other. One or more content items can be presented on either of the controlling device and the presentation device.

In some implementations, some content items, such as a pre-roll advertisement typically presented by conventional systems on presentation devices (e.g., before a presented video), can instead or additionally be presented on the controlling device. In this example, the pre-roll advertisement presented on the controlling device can be the same as, or different from, the advertisement presented on the presentation device.

Some implementations can allow users to specify whether content items are to be provided on their controlling devices as described herein. For example, users can specify user settings and/or preferences that indicate that certain ones of their controlling devices are allowed to receive content items related to content presented on their presentation devices. Other settings, for example, can specify conditions or aspects of content presentation, e.g., under what conditions permission is granted to provide the content items, such as while watching videos but not full-length movies. Several examples are described below. One typical example includes the use of a controlling device (e.g., a mobile telephone) that is used to control content presented on a presentation device (e.g., a co-located television set). In some implementations, the presentation device may receive the content for presentation directly from the source (as opposed to through the controlling device). Other examples are possible.

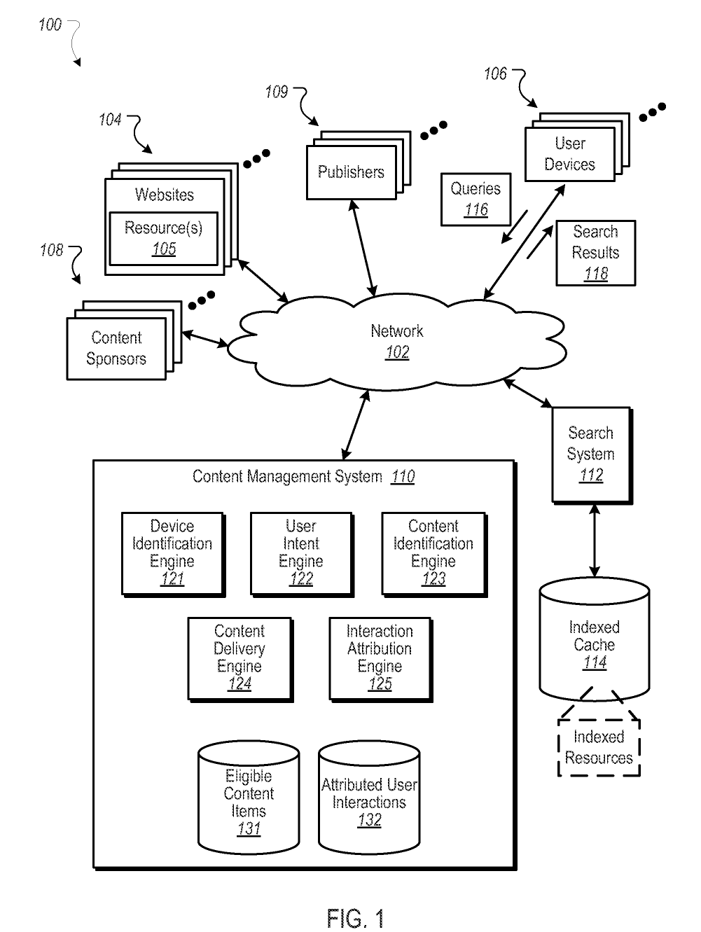

FIG. 1 is a block diagram of an example environment 100 for delivering content. The example environment 100 includes a content management system 110 for selecting and providing content in response to requests for content. The example environment 100 includes a network 102, such as a local area network (LAN), a wide area network (WAN), the Internet, or a combination thereof. The network 102 connects websites 104, user devices 106, content sponsors 108 (e.g., advertisers), publishers 109, and the content management system 110. The example environment 100 may include many thousands of websites 104, user devices 106, content sponsors 108 and publishers 109.

The environment 100 can include plural data stores, which can be stored locally by the content management system 110, stored somewhere else and accessible using the network 102, generated as needed from various data sources, or some combination of these. A data store of eligible content items 131, for example, can include different types of content items such as advertisements, multi-media content items (e.g., videos), graphical display content items, audio content item, executable software applications, Internet resources, and other formats or types of content items. A data store of attributed user interactions 132, for example, can include information about user interactions that are associated with the presentation of content. An example attribution can be a conversion by a user that occurs on a controlling device that is associated with a content item presented on a co-located presentation device under the control of the controlling device.

The content management system 110 can include plural engines, some or all of which may be combined or separate, and may be co-located or distributed (e.g., connected over the network 102). A device identification engine 121, for example, can identify a controlling device that includes a display for presenting content to a user. For example, the controlling device can be the user's mobile communication device (e.g., smart phone, cell phone, etc.), a tablet computer, a laptop computer, or some other mobile or non-mobile communication device.

A user intent engine 122, for example, can receive an indication from an application running on the controlling device of an intent by the user to receive/present a first content item on a separate but co-located presentation device. For example, the received indication can also include a request for a content item (e.g., a particular video) to be presented on the presentation device.

A content identification engine 123, for example, can select one or more additional content items for simultaneous or near simultaneous delivery on the controlling device while presenting the first content item on the co-located presentation device. For example, the content identification engine 123 can identify advertisements that are related to a user-specified video to be presented on the presentation device.

A content delivery engine 124, for example, can deliver the one or more additional content items, including a second different content item, to the controlling device for presentation coincident with the presentation of the first content item on the co-located presentation device. For example, the content delivery engine 124 can deliver the selected video to the user's presentation device and the related one or more advertisements to the user's controlling device.

An interaction attribution engine 125, for example, can attribute a user interaction with an interaction point in the second different content item with the presentation of the first content item. For example, the attributed interaction can be a conversion on an advertisement presented on the controlling device that is associated with the presentation of the video or other content on the presentation device.

A website 104 includes one or more resources 105 associated with a domain name and hosted by one or more servers. An example website is a collection of webpages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images, video and sounds, that may include embedded information (such as meta-information hyperlinks) and/or embedded instructions (such as JavaScript™ scripts).

A user device 106 is an electronic device that is under control of a user and is capable of requesting and receiving resources over the network 102. Example user devices 106 include personal computers (PCs), televisions with one or more processors embedded therein or coupled thereto, set-top boxes, gaming consoles, mobile communication devices (e.g., smartphones), tablet computers and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or webpage, in which content can be presented. These specified portions of the resource or user display are referred to as slots (e.g., ad slots).

To facilitate searching of these resources, the environment 100 can include a search system 112 that identifies the resources by, for example, crawling and indexing the resources provided by the content publishers on the websites 104. Data about the resources can be indexed based on the resource to which the data corresponds. The indexed and, optionally, cached copies of the resources can be stored in an indexed cache 114.

Search results pages can also include one or more slots in which other content items (e.g., advertisements) can be presented. In some implementations, slots on search results pages or other webpages can include content slots for content items that have been provided as part of a reservation process. In a reservation process, a publisher and a content item sponsor enter into an agreement where the publisher agrees to publish a given content item (or campaign) in accordance with a schedule (e.g., provide 1000 impressions by date X) or other publication criteria. In some implementations, content items that are selected to fill the requests for content slots can be selected based, at least in part, on priorities associated with a reservation process (e.g., based on urgency to fulfill a reservation).

When a resource 105, search results 118 and/or other content (e.g., a video) are requested by a user device 106, the content management system 110 receives a request for content. The request for content can include characteristics of the slots that are defined for the requested resource or search results page, and can be provided to the content management system 110.

For example, a reference (e.g., URL) to the resource for which the slot is defined, a size of the slot, and/or media types that are available for presentation in the slot can be provided to the content management system 110 in association with a given request. Similarly, keywords associated with a requested resource (“resource keywords”) or a search query 116 for which search results are requested can also be provided to the content management system 110 to facilitate identification of content that is relevant to the resource or search query 116.

Based at least in part on data included in the request, the content management system 110 can select content that is eligible to be provided in response to the request (“eligible content items”). For example, eligible content items can include eligible ads having characteristics matching the characteristics of ad slots and that are identified as relevant to specified resource keywords or search queries 116. In some implementations, the selection of the eligible content items can further depend on user signals, such as demographic signals, behavioral signals or other signals derived from a user profile.

For situations in which the systems discussed here collect and/or use personal information about users, the users may be provided with an opportunity to enable/disable or control programs or features that may collect and/or use personal information (e.g., information about a user's social network, social actions or activities, a user's preferences or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

The content management system 110 can select from the eligible content items that are to be provided for presentation in slots of a resource or search results page based at least in part on results of an auction (or by some other selection process). For example, for the eligible content items, the content management system 110 can receive offers from content sponsors 108 and allocate the slots, based at least in part on the received offers (e.g., based on the highest bidders at the conclusion of the auction or based on other criteria, such as those related to satisfying open reservations and a value of learning). The offers represent the amounts that the content sponsors are willing to pay for presentation of (or selection of or other interaction with) their content with a resource or search results page. For example, an offer can specify an amount that a content sponsor is willing to pay for each 1000 impressions (i.e., presentations) of the content item, referred to as a CPM bid. Alternatively, the offer can specify an amount that the content sponsor is willing to pay (e.g., a cost per engagement) for a selection (i.e., a click-through) of the content item or a conversion following selection of the content item. For example, the selected content item can be determined based on the offers alone, or based on the offers of each content sponsor being multiplied by one or more factors, such as quality scores derived from content performance, landing page scores, a value of learning, and/or other factors.

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a webpage, and consummates a purchase there before leaving that webpage. A conversion can also be defined by a content provider to be any measurable or observable user action, such as downloading a white paper, navigating to at least a given depth of a website, viewing at least a certain number of webpages, spending at least a predetermined amount of time on a web site or webpage, registering on a website, experiencing media, or performing a social action regarding a content item (e.g., an ad), such as endorsing, republishing or sharing the content item. Other actions that constitute a conversion can also be used.

In some implementations, conversions can be more likely to occur in situations in which related content is presented simultaneously, nearly simultaneously, coincidently, or within a predetermined amount of time on a user's presentation and controlling devices. For example, the user may be more likely to convert after being presented, on the controlling device, an advertisement that is related to, and coordinated with, a video that is presented on the presentation device. Further, the controlling device may include capabilities that allow for user interaction (e.g., selection of links, interaction with call-to-action features, or other interaction points) that may not be available on the presentation device, thus limiting the user's ability to interact with content presented on the presentation device.

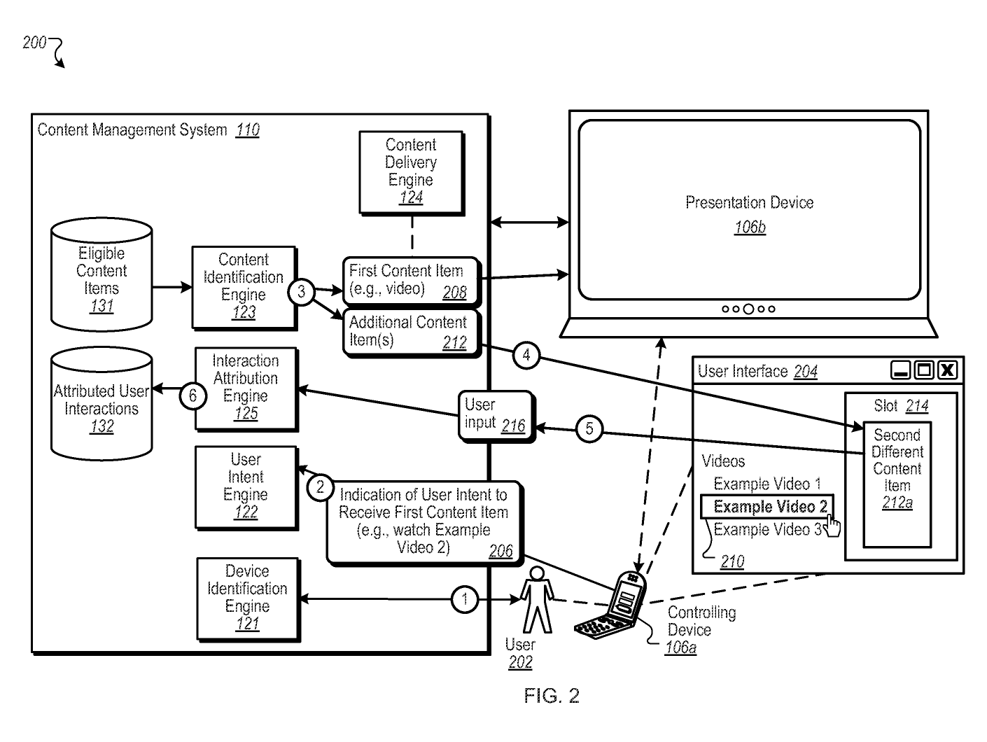

FIG. 2 shows an example system 200 for providing content. For example, in the system 200, the content management system 110 can receive an indication from an application running on a controlling device 106a of an intent by the user 202 to receive/present a first content item on a separate but co-located presentation device 106b. Example controlling devices 106a can include a mobile communication device, a tablet computer, or some other device capable of running applications to control other devices. Example presentation devices 106b can include a television, such as the user's Internet-connected television. The controlling device 106a can be, for example, a laptop computer, a tablet computer, a smartphone, or some other mobile or non-mobile communication device of a user 202. In response to the received indication, the content management system 110 can provide content items for simultaneous or near simultaneous delivery on both devices. In some implementations, providing content within the system 200 can occur in the following example sequence of stages.

At stage 1, for example, the device identification engine 121 can identify the controlling device 106a that includes a display (e.g., a user interface 204) for presenting content to the user 202. For example, the user interface 204 can be an application that interfaces with the presentation devices 106b, such as an application that selects video or other content (e.g., from the Internet). The user 202, in this example, can be a user using the controlling device 106a to control content selected for presentation on the presentation device 106b. In some implementations, the controlling device 106a can include or access an electronic program guide (EPG) for content to be presented on the presentation devices 106b.

At stage 2, for example, the user intent engine 122 can receive an indication 206 from an application running on the controlling device 106a of an intent by the user 202 to receive a first content item 208 on the separate but co-located presentation device 106b. For example, the indication 206 can be received subsequent to the user 202 using the user interface 204 to select a control 210 for identifying a particular video to be presented on the presentation device 106b. The first content item 208, for example, can be a video (e.g., that includes rich content) that can be streamed to the presentation device 106b or that uses other enhanced presentation capabilities of the device. The first content item 208, for example, can be one of the eligible content items 131, e.g., a particular video selected by the user 202 using the user interface 204 for presentation on the presentation device 106b.

At stage 3, for example, the content identification engine 123 can select one or more additional content items 212 for simultaneous or near simultaneous delivery on the controlling device 106a while presenting the first content item 208 on the co-located presentation device 106b. The video, for example, may include food-related scenes, such as a part of the video that shows a person removing a pizza from the oven or drinking a beverage. In this example, conventional systems that select related content items may select a pre-roll advertisement that typically precedes the selected video. In this example, as the video is to be presented on the presentation device 106b, content items, such as food-related advertisements, can be selected for simultaneous presentation on the controlling device 106a. For example, the content identification engine 123 can select one or more food-related advertisements that are selected based, at least in part, on the first content item 208, e.g., a video for which a pre-roll food-related advertisement is typically selected. In some implementations, the one or more additional content items can be identified from the eligible content items 131. The additional content items 212, for example, can include one or more interaction points that are configured to enable the user 202 to interact with the one or more additional content items 212. While pre-roll items are described, other content can be selected, such as to be displayed coincident with a particular portion of a selected presentation item.

At stage 4, for example, the content delivery engine 124 can deliver the one or more additional content items 212 to the controlling device 106a for presentation coincident with the presentation of the first content item 208 on the co-located presentation device 106b. The additional content items 212 can include a second different content item 212a (e.g., a pizza advertisement) that includes a first interaction point, e.g., with which the user 202 can interact with the second different content item 212a. In some implementations, the second different content item 212a can be presented in a content item slot 214 in the user interface 204.

At stage 5, for example, the content management system 110 can receive user input 216 in the form of an interaction with the first interaction point in the second different content item 212a. For example, if the user 202 interacts with the pizza advertisement, e.g., by clicking on a link in the advertisement or by performing some other action, the controlling device 106a can send the user input 216 that identifies the interaction.

At stage 6, for example, the interaction attribution engine 125 can attribute the interaction (e.g., the user input 216) to the presentation of the first content item 208. For example, information associated with the user's interaction with the pizza advertisement can be stored in association with information for the provided first content item 208 (along with being attributed to the particular content that is being shown on the controlling device). In some implementations, the attributed interaction information can be stored, for example, in the data store of attributed user interactions 132. In some implementations, the stored information can include, for example, conversions that are linked to the presentation of content on the presentation device.

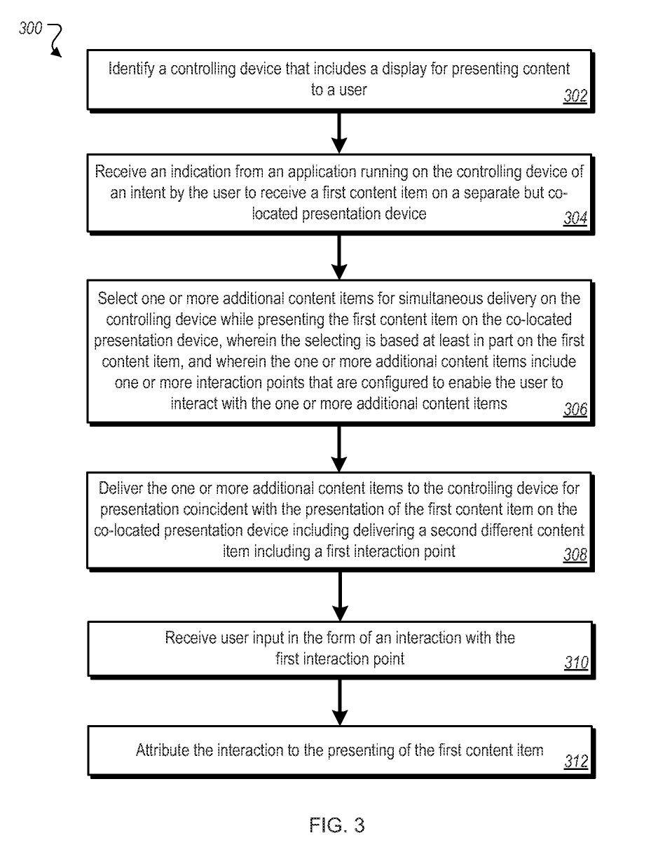

FIG. 3 is a flowchart of an example process 300 for providing additional content on a device controlling a presentation device. In some implementations, the content management system 110 can perform stages of the process 300 using instructions that are executed by one or more processors. FIGS. 1-2 are used to provide example structures for performing the steps of the process 300.

A controlling device is identified that includes a display for presenting content to a user (302). For example, the device identification engine 121 can identify the controlling device 106a as a device that is controlling the presentation device 106b and is capable of receiving content, such as advertisements. The identification can occur, for example, after a message or other communication is sent by the controlling device 106a to the content management system 110. In some implementations, the identification can occur subsequent to receiving a request for content, either for content to be presented on the controlling device 106a or the presentation device 106b.

An indication is received from an application running on the controlling device of an intent by the user to receive a first content item on a separate but co-located presentation device (304). As an example, an application executing on the controlling device 106a can provide the indication 206 to the content management system 110 that includes information associated with an intent by the user 202 to watch a video on the presentation device 106b (e.g., notification of a selection can be received). The application can be, for example, an application that provides the user interface 204. The indication 206, for example, can be received subsequent to the user 202 using the user interface 204 to select a control 210 for a particular content item (e.g., a video) to be presented on the presentation device 106b. The first content item (e.g., first content item 208) can be a video containing rich content that can be streamed to the presentation device 106b or that uses other enhanced presentation capabilities of the presentation device. Also, the first content item 208, for example, can be one of the eligible content items 131, e.g., a particular video selected by the user 202 (e.g., using the user interface 204) for presentation on the presentation device 106b.

In some implementations, the controlling device can be a mobile communication device or a tablet computer, and the presentation device can be a television. For example, the user 202 can use a smartphone or other mobile device (or a non-mobile device, such as a personal computer) to control the presentation of content on a flat-screen television or other device in the same room or otherwise nearby.

In some implementations, receiving the indication of the intent by the user can include receiving a request to initiate a session for presenting content on the co-located presentation device, and the request can include an identifier for the first content item. For example, the indication 206 can identify “Example Video 2” as the video that the user 202 wants to see. The indication 206 can also include, for example, information that a session is to be initiated between the controlling device 106a and the presentation device 106b, on which content (e.g., the selected video) is to be provided.

One or more additional content items are selected for simultaneous or near simultaneous delivery on the controlling device while presenting the first content item on the co-located presentation device (306). The selecting is based, at least in part, on the first content item, and the one or more additional content items include one or more interaction points that are configured to enable the user to interact with the one or more additional content items. For example, in response to the received indication 206 received from the controlling device 106a, the content identification engine 123 can select the first content item 208 and the additional content items 212. The first content item 208, for example, can be the video selected by the user 202 in the user interface 204 for presentation on the presentation device 106b. The additional content items 212, for example, can be one or more advertisements selected for presentation on the controlling device 106a and that are selected based in part on the selected video. The additional content items 212, for example, can include interaction points by which the user 202 can interact with the content items (e.g., advertisements). In some implementations, one of the additional content items 212 can be a pre-roll advertisement that is provided to both devices 106a and 106b, to be used in a mirrored presentation.

In some implementations, selecting one or more additional content items can include identifying eligible content items from an inventory of content items (e.g., the eligible content items 131). The eligible content items 131 can include, for example, content items that are adapted for coordinated presentation on the controlling device in view of simultaneously displayed content on the co-located presentation device. For example, the eligible content items 131 can include content items that content sponsors have provided specifically for (or that are suitable in) situations in which content can be provided, e.g., to the controlling device 106a and the co-located presentation device 106b.

In some implementations, selecting the one or more additional content items can include selecting a campaign associated with a content sponsor for providing the second different content item. The campaign can have two or more associated content items, one for presentation on the co-located presentation device and one for presentation on the controlling device. For example, when selecting the content items 208 and 212, the content identification engine 123 can select from eligible content items 131 that are specifically defined by content sponsors 108 to provide content to combinations of controlling and presentation devices.

The one or more additional content items are delivered to the controlling device for presentation coincident with the presentation of the first content item on the co-located presentation device including delivering a second different content item including a first interaction point (308). As an example, the content delivery engine 124 can deliver the one or more additional content items 212 (e.g., food-related advertisements) to the controlling device 106a for presentation coincident with the presentation of the first content item 208 (e.g., the video) on the co-located presentation device 106b. The second different content item 212a, for example, can be a pizza advertisement that includes a first interaction point with which the user 202 can interact.

In some implementations, the first content item can be an Internet content item, and the second different content item can be selected based, at least in part, on content or metadata of or associated with the Internet content item. The Internet content item can be, for example, a multi-media content item, a graphical display item, an audio content item, an executable software application, or an Internet resource. For example, the content item that the user 202 selects for presentation on the presentation device 106b can be any type of content item (e.g., the video that includes food-related segments). The content identification engine 123, for example, can select advertisements for presentation on the controlling device 106a based on information associated with the video, e.g., that may indicate that food-related advertisements are ideal for simultaneous presentation with the video.

In some implementations, the first content item can be a video content item, and the video content item can include or be associated with a first advertisement that is presented before, during or after the presentation of the video content item. The second different content item can be a second advertisement that is related to the first advertisement. For example, the content identification engine 123 can select the second different content item 212a which can be a food-related advertisement that is related to the food-related advertisement that is displayed as a pre-roll advertisement, e.g., before the video starts.

In some implementations, the second advertisement can be a mirror of the first advertisement. For example, the same advertisement (or complementary advertisements) can appear simultaneously on the controlling device 106a and the presentation device 106b. In some implementations, the second advertisement can include an interaction point that corresponds to an interaction point that is presented but disabled or otherwise unable to be interacted with on the first advertisement. For example, interaction points that are enabled on the advertisement presented on the user's smartphone may be disabled on the same advertisement presented on the flat-screen television.

User input is received that is in the form of an interaction with the first interaction point (310). As an example, the user 202 may interact with the pizza advertisement, e.g., by clicking on a link in the advertisement or by performing some other action. Based on this interaction, for example, the controlling device 106a can send the user input 216 to the content management system 110. The user input 216, can identify the user interaction, e.g., associated with the first interaction point in the second different content item 212a (e.g., the pizza advertisement).

In some implementations, the process 300 can further include providing additional content to the co-located presentation device based on the interaction. For example, based on interactions by the user 202 using the controlling device 106a, the content management system 110 can provide additional content, including advertisements, to the presentation device 106b.

The interaction is attributed to the presentation of the first content item (312). As an example, the interaction attribution engine 125 can generate and store information in the attributed user interactions 132 that attributes the user input 216 to an advertisement presented on the presentation device 106b.

In some implementations, attributing the interaction can include crediting a conversion that is related to the interaction to the presentation of the first content item. For example, the interaction attribution engine 125 can attribute selection by the user 202 of a link on the second different content item 212a (e.g., a food-related advertisement) as a conversion associated with a complementary advertisement presented on the presentation device 106b.

In some implementations, the process 300 can further include providing an advertiser interface for configuring a campaign, the campaign including both a first advertisement to be shown in conjunction with the first content item when it is presented on the co-located presentation device and a second advertisement to be presented on the controlling device coincident with the presentation of the first advertisement on the co-located presentation device. For example, content sponsor interfaces can be presented for use by content sponsors for designating when and how content items are to be simultaneously presented on controlling and presentation devices. Content sponsors can identify, for example, complementary advertisements, e.g., one advertisement to be shown on devices such as the controlling device 106a, and the other related advertisement to be shown on devices such as the presentation device 106b. The interfaces can also include, for example, selection criteria for identifying content to use, parameters indicating when the same content items are to be mirrored, information identifying enabled and disabled interaction points, and other information.

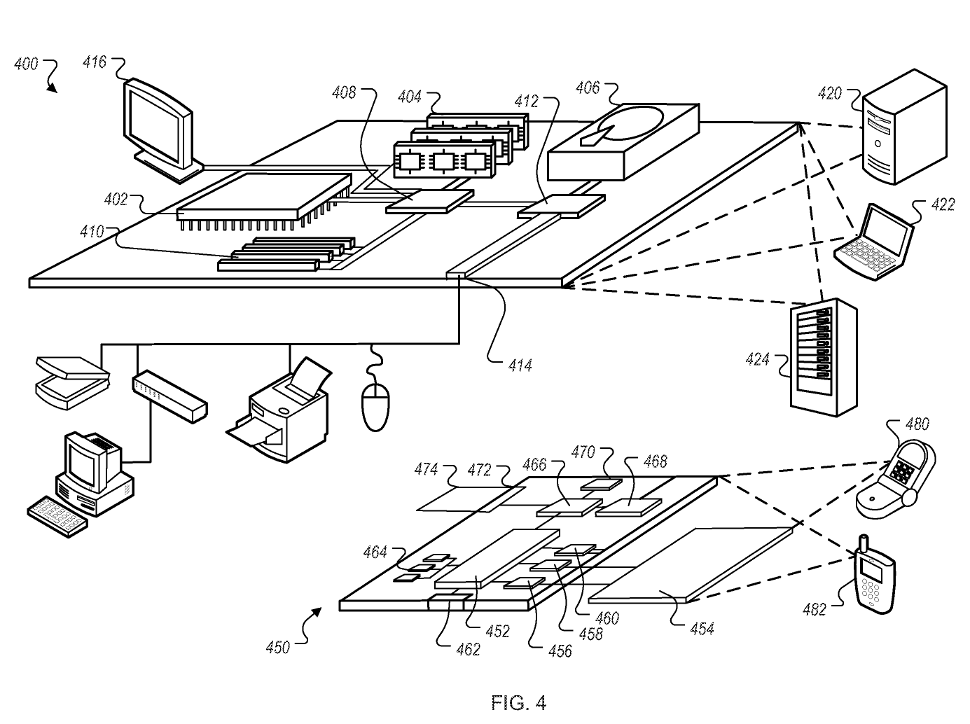

FIG. 4 is a block diagram of example computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 400 is further intended to represent any other typically non-mobile devices, such as televisions or other electronic devices with one or more processers embedded therein or attached thereto. Computing device 450 is intended to represent various forms of mobile devices, such as personal digital assistants, cellular telephones, smartphones, and other computing devices. The components shown here, their connections and relationships, and their functions, are meant to be examples only, and are not meant to limit implementations of the inventions described and/or claimed in this document.

Computing device 400 includes a processor 402, memory 404, a storage device 406, a high-speed controller 408 connecting to memory 404 and high-speed expansion ports 410, and a low-speed controller 412 connecting to low-speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high-speed controller 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high-speed controller 408 manages bandwidth-intensive operations for the computing device 400, while the low-speed controller 412 manages lower bandwidth-intensive operations. Such allocation of duties is an example only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed bus 414. The low-speed bus 414 (e.g., a low-speed expansion port), which may include various communication ports (e.g., USB, Bluetooth® , Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as computing device 450. Each of such devices may contain one or more of computing devices 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The computing device 450 may also be provided with a storage device, such as a micro-drive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the computing device 450, such as control of user interfaces, applications run by computing device 450, and wireless communication by computing device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of computing device 450 with other devices. External interface 462 may provide, for example, for wired communication (e.g., via a docking procedure) or for wireless communication (e.g., via Bluetooth® or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to computing device 450 through expansion interface 472, which may include, for example, a subscriber identification module (SIM) card interface. Such expansion memory 474 may provide extra storage space for computing device 450, or may also store applications or other information for computing device 450. Specifically, expansion memory 474 may include instructions to carry out or supplement the processes described above, and may include secure information also. Thus, for example, expansion memory 474 may be provide as a security module for computing device 450, and may be programmed with instructions that permit secure use of computing device 450. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Computing device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 468 (e.g., a radio-frequency transceiver). In addition, short-range communication may occur, such as using a Bluetooth®, WiFi, or other such transceiver (not shown). In addition, GPS receiver module 470 may provide additional wireless data to computing device 450, which may be used as appropriate by applications running on computing device 450.

Computing device 450 may also communicate audibly using audio codec 460, which may receive spoken information from a user and convert it to usable digital information. Audio codec 460 may likewise generate audible sound for a user, such as through a speaker, e.g., in a handset of computing device 450. Such sound may include sound from voice telephone calls, may include recorded sound (e.g., voice messages, music files, etc.) and may also include sound generated by applications operating on computing device 450.

The computing device 450 may be implemented in a number of different forms, as shown in the figure. For example, it may be implemented as a cellular telephone 480. It may also be implemented as part of a smartphone 482, personal digital assistant, or other mobile device.

Various implementations of the systems and techniques described here can be realized in digital electronic circuitry, integrated circuitry, specially designed ASICs (application specific integrated circuits), computer hardware, firmware, software, and/or combinations thereof These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. Other programming paradigms can be used, e.g., functional programming, logical programming, or other programming. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1-20. (canceled)

21. A method, comprising:
transmitting, by a controlling device to a content management system, a request to present a first content item on a presentation device separate from the controlling device;
receiving, by the controlling device from the content management system, a second content item, different from the first content item and having the same duration as the first content item, selected by the content management based on an association between the first content item and second content item and an identification of the second content as eligible for coordinated presentation on the controlling device in view of the simultaneously displayed first content item on the presentation device, the presentation device co-located with the controlling device;
initiating simultaneous display, by the controlling device, of the second content item on the controlling device with display of the first content item on the presentation device;
detecting an interaction with the second content item, by the controlling device; and
transmitting, by the controlling device to an interaction attribution engine, an identification of the interaction with the second content item, the interaction attribution engine associating the interaction with the first content item.

22. The method of claim 21, wherein receiving the second content item further comprises:
receiving a list of content items for display on the presentation device; and
receiving the second content item for display on the controlling device.

23. The method of claim 22, wherein displaying the second content item further comprises displaying the list of content items for display on the presentation device separately from the second content item.

24. The method of claim 21, wherein transmitting the request to present the first content item on the presentation device further comprises:
displaying a list of content items for display on the presentation device;
detecting an interaction with an identifier in the list of content items corresponding to the first content item; and
transmitting the request to the content management system to present the first content item on the presentation device, responsive to detection of the interaction with the identifier.

25. The method of claim 21, further comprising transmitting, by the controlling device, an identification of the controlling device to the content management system.

26. (canceled)

27. The method of claim 21, wherein the second content item is selected based on an association between the second content item and a content sponsor of the first content item.

28. A method, comprising:
receiving, by a content management system from a controlling device, a request to present a first content item on a presentation device separate from and co-located with the controlling device;
selecting, by the content management system, a second content item different from and associated with the first content item, the second content item having the same duration as the first content item, responsive to an identification of the second content as eligible for coordinated presentation on the controlling device in view of the simultaneously displayed first content item on the presentation device;
transmitting, by the content management system to the presentation device, the first content item for display; and
transmitting, by the content management system to the controller device, the second content item for display, the controller device initiating simultaneous display of the second content item with display of the first content item on the presentation device.

29. The method of claim 28, further comprising receiving, by an interaction attribution engine of the content management system from the controlling device, an identification of an interaction by a user of the controlling device with the second content item; and
associating, by the interaction attribution engine, the interaction with the first content item.

30. The method of claim 28, wherein transmitting the second content item to the controller device further comprises:
transmitting a list of content items for display on the presentation device; and
transmitting the second content item for display on the controlling device;
the controller device displaying the list of content items separately from the second content item.

31. The method of claim 30, wherein the list of content items identifies items of video content for display on the presentation device, and wherein the second content item is an advertisement associated with the first content item.

32. The method of claim 28, further comprising receiving, by the content management system from the controlling device, an identification of the controlling device.

33. (canceled)

34. (canceled)

35. The method of claim 28, further comprising selecting the second content item, by the content management system, based on an association between the second content item and a content sponsor of the first content item.

36. A content management system, comprising:
a network interface;
a content storage device;
a user intent engine in communication via the network interface to a controlling device configured to:
receive, from the controlling device, a request to present a first content item on a presentation device separate from and co-located with the controlling device; and
a content identification engine in communication via the network interface to the presentation device configured to:
retrieve the first content item from the content storage device,
transmit the first content item to the presentation device for display,
select a second content item different from and associated with the first content item from the content storage device, the second content item having the same duration as the first content item, responsive to an identification of the second content as eligible for coordinated presentation on the controlling device in view of the simultaneously displayed first content item on the presentation device, and
transmit the second content item to the controller device for simultaneous display with display of the first content item on the presentation device.

37. The system of claim 36, further comprising an interaction attribution engine configured to:
receive, from the controller device, an identification of an interaction with the second content item, and associate the interaction with the first content item.

38. The system of claim 36, wherein the content identification engine is further configured to transmit a list of content items for display on the presentation device, the controller device displaying the list of content items separately from the second content item.

39. The system of claim 38, wherein the list of content items identifies items of video content for display on the presentation device, and wherein the second content item is an advertisement associated with the first content item.

40. The system of claim 36, further comprising a device identification engine configured to identify the controlling device, responsive to receipt of an identification of the controlling device from the controlling device.
